(19) United States
(12) Patent Application Publication
(10) Pub. No.: US 2004/0254940 A1
(43) Pub. Date: Dec. 16, 2004

(54) Digital media distribution method and system

(76) Inventor: Hector Cesar Brush, Cupertino, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/769,468

(22) Filed: Jan. 30, 2004

Related U.S. Application Data
(60) Provisional application No. 60/443,965, filed on Jan. 31, 2003.

(51) Int. Cl. G06F 7/00

(52) U.S. Cl. 707/100

(57) ABSTRACT

Current methods of distributing digital media such as movies, video games, and music to consumers involves manufacture and distribution of a fixed physical media such as a DVD. For the rental market, the manufacturing of the media and distribution costs comprise a significant portion of the expenses related to creating the digital media. In addition, the consumer who rents a digital media title is forced to return the media to the rental outlet by a certain time or face late fees. This application describes a new method and system of distributing digital media that addresses many of the shortcomings of current media distribution practices.

### RELATED APPLICATIONS

This application claims priority under 35 U.S.C. 119(e) to provisional application No. 60/443,965 filed on Jan. 31, 2003 titled “METHOD AND APPARATUS FOR MEDIA CARD AND MEDIA PLAYER SYSTEM.”

### FIELD

The invention generally relates to the distribution of digital media.

### BACKGROUND

Too often these days busy people do not rent movies because of the hassle of having to return a movie before it has been watched or facing a late fee. At the same time VCR's are being phased out as DVD's become the dominant rental format. HDTV is fast supplanting analog television with a far superior picture. Accordingly, consumers have become accustom to high quality video.

Unfortunately, the media rental infrastructure is not keeping pace with consumer demands. Rental outlets routinely run out of popular new releases. Floor space restrictions prevent rental outlets from maintaining comprehensive collections of titles. The same disadvantages exist with the distribution of video games and music.

Given consumer demand for high quality digital media and the disadvantages inherent in physical digital media such as CD's and DVD's, there is a need for a new digital media distribution system.

### OBJECTS AND ADVANTAGES

In view of the above, it is a primary object of the present invention to provide a digital media distribution method and system based upon a portable rewritable nonvolatile digital media card that interfaces with a digital media distribution infrastructure in order to provide consumers with digital media content.

One advantage is that the digital media card eliminates the need for digital media creators to release their products on physical media, thereby saving significant manufacturing and distribution costs. Another advantage is that unlimited copies can be distributed with minimal cost. Media vendors would never run out of popular titles, and they would not have any floor space issues associated with physical media. A digital media producer can have their entire media library available at any retail location and the distribution occurs faster than current practices. The digital media can also be encrypted so that intellectual property rights are preserved.

A further advantage is that the consumer does not have to return any physical media to a rental outlet, thereby saving time and transportation costs. Consequently there are no late fees. In fact, when traveling long distances, a consumer can rent a title and continue on their road trip without worry, because there is no need to return anything. Another advantage is that the digital media can simply be set to expire at a certain time and date, thereby ensuring that the rental period complies with the rental contract. Optionally, the digital media can have a set number of uses. The system provides unparalleled flexibility for both content creators and consumers.

### SUMMARY

This document describes a digital media distribution system with a media distribution infrastructure that interfaces with a portable digital media card. Also described is a method for distributing digital media. In addition, a method of collecting revenue for distributing digital media is described.

### BRIEF DESCRIPTION OF THE DRAWINGS

FIGS. 1 A,B show an example of a media player.

FIGS. 2 A,B show an example of a media card.

FIG. 3 shows an example of a distribution system.

FIG. 4 shows an exemplary method for distributing digital media.

FIG. 5 shows an exemplary method of collecting revenue for distributing digital media.

### DESCRIPTION

This document describes a novel digital media distribution method and system. The system uses a digital media card to store media that a consumer purchases or rents at a retailer. The media card can be erased and reused, thereby eliminating the wasted time and effort to return rental titles. Media obtained through the distribution system can be played on a media player.

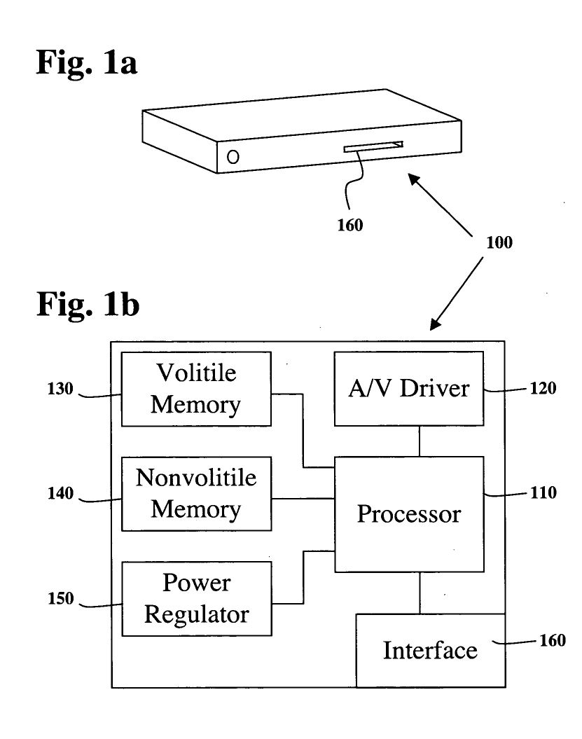

FIGS. 1 A,B show an example of a media player 100. The media player 100 is something that the consumer would have to play digital media such as movies, video games, or music in their home, office, or car. The media player 100 includes a processor 110, an audio/video driver 120, volatile memory 130, nonvolatile memory 140, a power regulator 150, and an interface slot 160. The processor 110 is connected to the audio/video driver 120, the volatile memory 130, the nonvolatile memory 140, the power regulator 150, and the interface slot 160.

The audio/video driver 120 may support various audio and video formats, which may be analog and/or digital. The formats used are those commonly found in consumer electronics and allow the media player 100 to be connected to the consumer's entertainment system for audio and/or video input. Ideally, the media player is compatible with current analog TV formats (NTSC for example), digital TV formats (HDTV for example), and popular audio formats (Dolby Surround Sound for example).

The media player has some volatile memory 130, such as RAM. The volatile memory 130 typically stores operating instructions, variables, and data for the processor and possibly other components. In addition, the volatile memory 130 may be used as a cache between the nonvolatile memory 140 and other components of the system.

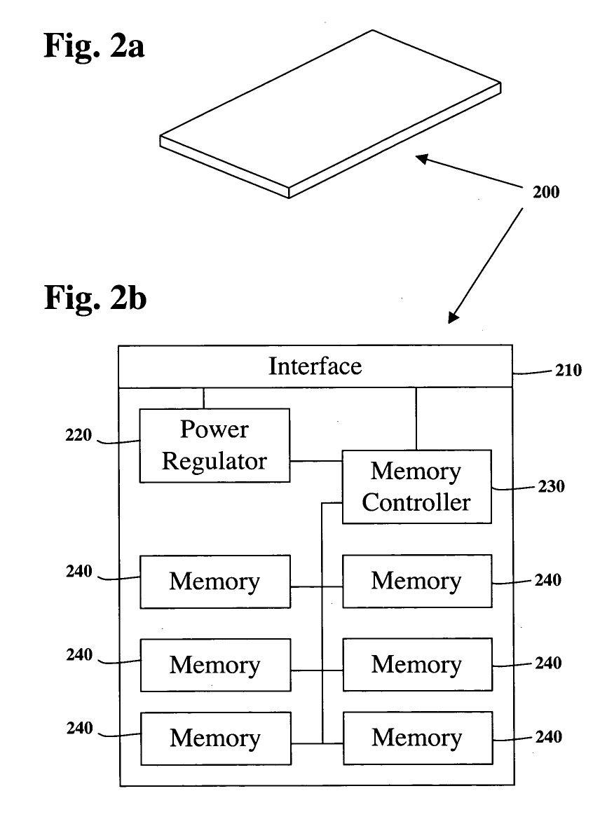

The nonvolatile memory 140 may store digital media titles transferred from a media card 200 (see FIG. 2) to the media player. This allows the media card 200 to be used for transferring other media titles while allowing the consumer to use media titles already purchased on the media player 100. Additionally, nonvolatile memory 140 may store the operating system or other components necessary for the operation of the media player 100. Examples of the nonvolatile memory 140 include flash memory, optical memory, and magnetic memory.

The interface slot 160 receives the media card 200. When connected, the media player 100 and the media card 200 can transfer digital media files or other information back and forth. Examples of the digital media files include movies, video games, and music. Of course, it is also possible to transfer files such as computer software and data files. The media player 100 transfers the digital files from the media card 200 to the nonvolatile memory 140. The content may then be used at a later time by the consumer.

FIG. 1A shows one example of a consumer friendly media player 100. The media player 100 is a small box capable of reading, decoding, and playing a movie, a video game, or music transferred from a media card 200. The media player 100 may be capable of outputting multiple television formats on multiple connection types (such as composite, component, S-video, and digital cables). In addition, the media player 100 might also be capable of outputting HDTV format. The media player 100 may also provide useful features such as video editing, scene tilting, and special effects. The media player 100 desirably supports various audio standards such as multichannel television sound (MTS), second audio program (SAP), Dolby Digital, Dolby Pro Logic, Dolby Pro Logic 2, Dolby Surround, and digital theater systems (DTS).

Additional features that may be integrated into the media player 100 include standard video control features such as play, stop, fast forward, reverse, and pause. Other examples of integrated features include freeze frame, frame advanced, skip forward or backward, forward or reverse searching, slow motion, progressive scan vs. interlacing, resolution upconvert and downconvert, regional coding, parental block, parental rating, digital zoom, screen fit, multi-angle view, and subtitles.

FIGS. 2 A,B shows an example of a media card 200. The exemplary media card 200 includes an interface connector 210, a power regulator 220, a memory controller 230, and nonvolatile memory 240. In this example the controller 230 is connected to the interface connector 210, the power regulator 220, and the nonvolatile memory 240.

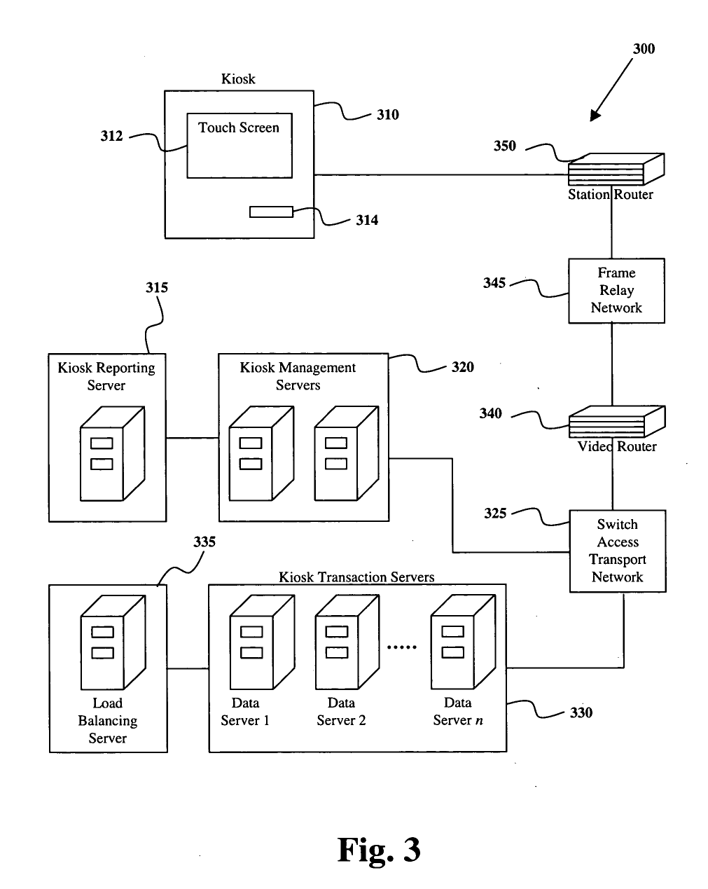

The nonvolatile memory 240 is suitable for storing digital files such as movies, games, music, software, or other types of data. For example, the media card 200 may receive and store in the nonvolatile memory 240 a movie downloaded from a distribution point such as a kiosk 310 (see FIG. 3). The media card 200 may also transfer the stored movie to a remote device such as a media player 100 or a computer.

The interface connector 210 allows the media card 200 to connect with a remote device. Examples of a remote device include a media player 100, a kiosk 310, or a computer.

The media card 200 may be any type of common flash memory card such as CompactFlash. The media card 200 may also be a flash memory card designed to be inserted into a laptop computer such as a PCMCIA flash memory card. The capacity of the memory card should provide sufficient memory space to contain one or more full-length movies in HDTV format with Dolby Digital surround sound. For example, an average HDTV movie takes up about 8 GB of memory using MPEG 2 compression and about 1.5 GB of memory using MPEG 4 compression. A movie with the visual quality of broadcast analog TV takes up about 500 MB using MPEG 2 compression. Optionally, a less expensive card may be used that only has enough capacity to store a video game or analog TV movie.

The memory may also store an internal date and time stamp that is associated with each digital media file that is stored on the media card 200. The date and time stamp facilitates erasing of the stored data after the prescribed time. Erasing the files stored on the media card 200 at a prescribed time and date constitutes a form usage contract enforcement and limits term of use for the stored information.

The media card 200 may also store an identification protocol, which identifies the media card 200 with a corresponding member ID. The member ID uniquely identifies the particular media card and an associated user.

FIG. 3 shows an example of a digital media distribution infrastructure 300. The example information distribution system 300 includes a kiosk 310, a kiosk reporting server 315, kiosk management servers 320, a switch 325, kiosk transaction servers 330, a load balancing server 335, a video router 340, a frame relay network 345, and a station router 350. Systems may be connected through wired and/or wireless connections.

The kiosk 310 includes a touch screen 312 and an interface connector 314. The touch screen 312 facilitates input and output between the user and the kiosk 310. Optionally, a display with a keyboard and/or pointing device may be used. The interface connector 314 receives the media card 200. When connected, the kiosk 310 and the media card 200 can transfer digital media files or other information back and forth.

The kiosk 310 may optionally have a way to store the commonly downloaded digital media titles (on a hard drive for example). By having local storage for popular titles at the kiosk 310, no additional bandwidth is consumed by transmitting the content from the transaction servers 330 to the kiosk 310. Thus, the kiosk 310 has enough storage to effectively serve as a cache for the most commonly downloaded titles. The kiosk 310 is one type of local distribution site. Another example of a local distribution sites is a personal computer connected to the internet or a satellite connection. Another example of a local distribution sites is an entertainment system component that is connected to the internet, local cable TV services, or a satellite connection.

The kiosk transaction servers 330 comprise a group of one or more data servers. These data servers store the digital media files and transfer them to kiosks 310 on demand. Although shown as one group of servers, there may be multiple groups of kiosk transaction servers 330 strategically located in various geographical locations to maximize data transmission rates and minimize costs.

The load balancing server 335 balances the data transmission loads of the kiosk transaction servers 330. The load balancing server 335 also directs the most appropriate kiosk transaction server (server with highest possible bandwidth for example) to transmit digital media to the correct kiosk 310. The load balancing server 335 decides when digital media files should be stored locally at a kiosk 310. Several factors may dictate the specific media that is stored at a given kiosk 310 such as the geographic location of the kiosk 310, demographics of the kiosk 310, prior media requests from the kiosk 310, or prepaid product placement at the kiosk 310.

The load balancing server 335 optimizes requests from one or more kiosks 310 based on factors such as capacity, availability, response time, bandwidth load, historical performance, and administrative weights of the kiosk transaction servers 330. As each request arrives, the load balancing server 335 provides intelligent decisions concerning which of the kiosk transaction servers 330 is best able to satisfy each coming request.

The kiosk management servers 320 comprise one or more servers and are configured to track the identity of the users, update financial the status of the users, track the downloading of digital content to each user, track the payment by the users, and update billing information. The kiosk management servers 320 observe data transactions while the kiosk transaction servers 330 conduct the transactions themselves.

The kiosk management servers 320 desirably manage workloads by establishing shop dependencies, setting event triggers, and managing workloads based on resource requirements. The kiosk management servers 320 also desirably enable digital media owners to perform statistical analysis and audit transaction data. Using features of the kiosk management servers 320 to automate, schedule, and control workloads maximizes data throughput and achieves high levels of customer service.

The kiosk reporting server 315 processes information complied by the kiosk management servers 320. The kiosk reporting server 315 tracks downloads of digital content by users and calculates royalty payments due to the owners of the digital media.

The following is an example of how the media distribution infrastructure 300 might work. A user purchases and owns a media card 200. The user goes to a retail outlet that has a kiosk 310 and browses the digital media tiles available for download. The user chooses which titles he wants to download, inserts the media card 200 into the interface connector 314, selects a method of payment (cash, credit card, or media debit account for example), and waits for the transfer to take place. If the kiosk 310 has any of the requested titles stored locally, then those titles are transferred to the media card 200. If not, then the kiosk 310 requests the non-locally stored titles from the kiosk transaction servers 330. The kiosk transaction servers 330 relay the request to the load balancing server 335, which assigns each transfer to a particular data server. The appropriate kiosk transaction servers 330 establish connections with the kiosk and transfer the digital media files. The kiosk 310 may transfer the files to the media card 200 as the files stream in or wait until the kiosk receives files in their entirety before transfer them to the media card 200. The kiosk management servers 320 track the file transfers and financial transaction, while the kiosk reporting server calculates royalty payments that are due based on the transfers and usage agreement.

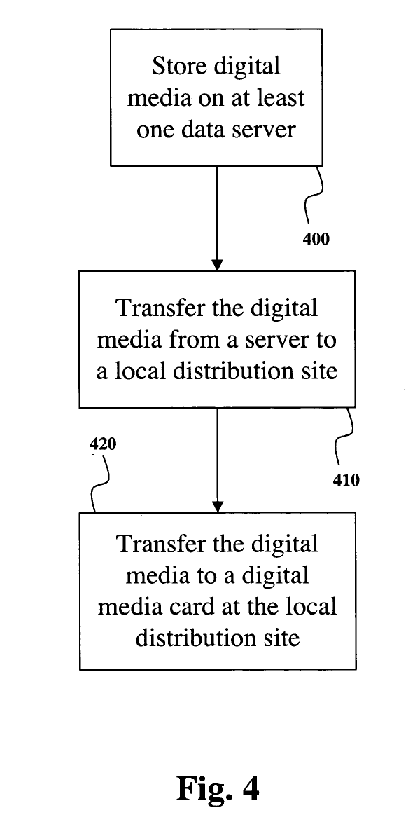

FIG. 4 illustrates a method for distributing digital media. In 400, digital media is stored on at least one data server. In 410, the digital media is transferred from a server to a local distribution site. In 420, the digital media is transferred to a digital media card at the local distribution site.

Another way of downloading digital content to the media card 200 is by downloading the digital content through a computer. The user can utilize the digital content on the computer or, if desired, remove the media card 200 attached to the computer and insert the media card 200 in another suitable device such as a media player 100 in order to utilize the digital content.

In yet another example of downloading digital content to the media card 200, a user could download digital media through a satellite capable device which is attached to the media card 200. An enhanced media player 100 with the appropriate hardware can enable this functionality.

Copy protection constitutes an important element in digital content distribution. It may be desirable to employ a copy protection scheme such as encryption to prevent unauthorized copying of the media. If encryption is employed, the digital media files would desirably be stored in their encrypted form throughout the media distribution infrastructure 300. An appropriate device, such as a media player 100, would have the components necessary to decrypt the encrypted media files and play them.

The media distribution infrastructure 300 accumulates revenue according to various criteria. For example, the amount of money charged to the user for the rights to use the digital media may depend on the quality of the media file. For example, movies in HDTV format might be priced higher than movies in analog format. Also, the price may depend on the type of digital media (movie vs. video game vs. music for example). In addition, the length of time that a digital media title has been released to the public may influence pricing. For example, a newly released video game may command a premium price, but a five year old title might cost significantly less.

Also, significant factors in pricing digital media may be influenced by the term of use. For a rental, the digital media can be priced to be valid for a certain length of time (two days for example). A time and date stamp would be associated with a given digital media file to enable this feature. Another way is to allow a certain number of uses (five viewing of a movie for example). A play number tag would be associated with a given digital media file to enable this feature. A combination of the two can also be employed (3 viewings or 30 days, whichever comes first for example).

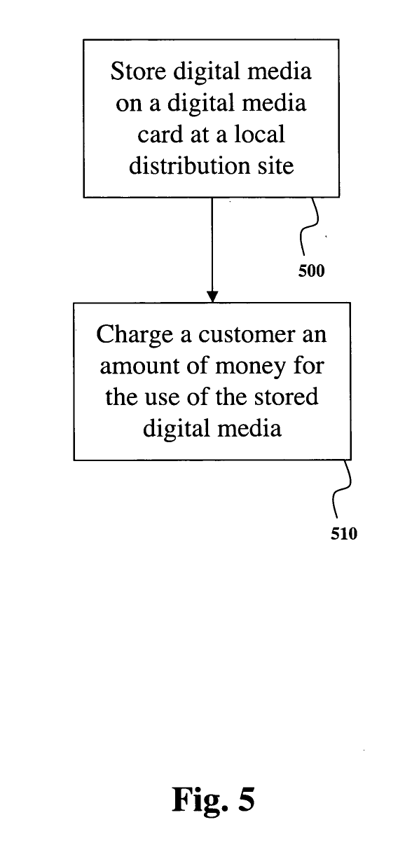

FIG. 5 illustrates a method of collecting revenue for distributing digital media. In 500, digital media is stored on a digital media card at a local distribution site. In 510, a customer is charged an amount of money for the use of the stored digital media.

It will be apparent to one skilled in the art that the described embodiments may be altered in many ways without departing from the spirit and scope of the invention. Accordingly, the scope of the invention should be determined by the following claims and their equivalents.

What is claimed is:

1. A system comprising:
a digital media distribution infrastructure, the distribution infrastructure storing a plurality of digital media files; and
a digital media card, the media card comprising a portable rewriteable nonvolatile memory, the media card receiving at least one digital media file from the distribution infrastructure.

2. The system of claim 1 further comprising a digital media player, the digital media player receiving the at least one digital media file from the media card, the digital media player being capable of playing the at least one digital media file.

3. The system of claim 1, wherein the distribution infrastructure comprises at least one data server, at least one transaction management server, and at least one local distribution site.

4. The system of claim 3, wherein, the at least one local distribution site receives digital media files from the at least one data server via a satellite connection.

5. The system of claim 3, wherein, the at least one local distribution site receives digital media files from the at least one data server via an internet connection.

6. The system of claim 1, wherein the at least one digital media file comprises a movie, a video game, or music.

7. The system of claim 1, wherein the at least one digital media file is encrypted.

8. The system of claim 1, wherein the media card has enough memory to store at least one movie in HDTV format.

9. The system of claim 1, wherein the media card comprises a flash memory card.

10. The system of claim 1, wherein the media card comprises a hard disk drive.

11. The system of claim 1, wherein each of the at least one digital media files has an associated expiration date and time.

12. The system of claim 11, wherein the at least one digital media file is erased after its associated expiration date and time elapses.

13. The system of claim 1, wherein each digital media file stored on the media card has play number tag, the play number tag being a predetermined number of times that that an associated digital media file can be played before being erased.

14. A method for distributing digital media comprising:
storing digital media on at least one data server;
transferring the digital media from the at least one server to a local distribution site; and
transferring the digital media to a digital media card at the local distribution site, the media card comprising a portable rewriteable nonvolatile memory.

15. The method of claim 14 further comprising playing the digital media on a media player.

16. The method of claim 14, further comprising distributing digital media transfer load among a plurality of data servers with a load balancing server.

17. The method of claim 14, wherein the local distribution site comprises a digital media kiosk, the kiosk having a display for customer input and output, the kiosk having an interface for connecting to the media card.

18. The method of claim 17, wherein the kiosk stores commonly used digital media.

19. The method of claim 17, further comprising tracking digital media kiosk transactions on at least one kiosk management server.

20. The method of claim 17, further comprising calculating royalty payments from digital media kiosk transactions.

21. The method of claim 14, wherein the local distribution site comprises a personal computer.

22. The method of claim 21, wherein the personal computer has an interface for connecting to the media card.

23. A method of collecting revenue for distributing digital media comprising:
storing digital media on a digital media card at a local distribution site, the media card comprising a portable rewriteable nonvolatile memory, and
charging a customer an amount of money for the use of the stored digital media.

24. The method of claim 23, wherein the amount charged depends on which type of digital media is stored.

25. The method of claim 23, wherein the amount charged depends on a time of usage for the digital media.

26. The method of claim 23, wherein the amount charged depends on a number of usings of the digital media.

27. The method of claim 23, wherein the amount charged depends on the image quality of the digital media.

28. The method of claim 23, wherein the amount charged depends the audio quality of the digital media.

29. The method of claim 23, wherein the amount charged depends the amount of time that the digital media has been released to the public.
